(19) United States
(12) Patent Application Publication
(10) Pub. No.: US 2009/0328001 A1
(43) Pub. Date: Dec. 31, 2009

(54) UNLOADABLE MANAGED CODE

(75) Inventors: Sergey Dubinets, Bellevue, WA (US); Anton V. Lapounov, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,875

(22) Filed: Jun. 27, 2008

(51) Int. Cl. G06F 9/44

(52) U.S. Cl. 717/120

(57) ABSTRACT

The claimed subject matter provides a system and/or a method that facilitates generating unloadable managed code. A set of static subroutines included in a library or an assembly can be converted into dynamic subroutines created at runtime of an application. A reflection component can extract information regarding a static subroutine to produce a full description of structure and data of the subroutine. A dynamic method component can create a dynamic subroutine based upon the full description such that the dynamic subroutine provides substantially equivalent functionality to the static subroutine. In addition, resources allocated to the dynamic subroutine can be reclaimed to prevent waste and/or application bloat.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implement code utilizing an object-oriented programming language (e.g., C#, Java . . . ). In accordance with such a paradigm, programmers will create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate creating unloadable code modules in a managed runtime environment. In particular, static subroutines included in a code module (e.g., a library or assembly) can be employed by an application developed for the managed runtime environment such that resources allocated for the subroutines can be efficiently reclaimed. In general, some code libraries or assemblies that include static subroutines can be dynamically loaded by an application at runtime but cannot be unloaded. Accordingly, the application cannot reduce resource utilization without shutting down the Application Domain. The subject innovation provides mechanisms to create dynamic subroutines at runtime that are equivalent to static subroutines included in a code module. The dynamic subroutines can be created, invoked and destroyed to enable efficient utilization of resources (e.g., memory).

A reflection component can be provided that extracts structural information related to a set of static subroutines. The structural information is employed to generate full descriptions of the static subroutines. According to an aspect, the structural information can include number and data types of subroutine parameters, number and data types of subroutine local variables, subroutine instructions (e.g., body of the subroutine), etc. In addition, a dynamic method component can be provided that creates dynamic subroutines at runtime based in part on the full descriptions of the static subroutines. The dynamic subroutines provide substantially equivalent functionality to corresponding static subroutines. An application developed for a managed runtime environment can invoked the dynamic subroutines and discard them when no longer needed. The managed runtime environment can reclaim resources utilized by discarded dynamic subroutines.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates creating managed code that can be dynamically unloaded.

FIG. 2 illustrates a block diagram of an exemplary system that facilitates generating unloadable managed code including a representative reflection component.

FIG. 3 illustrates a block diagram of an exemplary system that facilitates creating unloadable managed code in accordance with an aspect of the subject disclosure.

FIG. 4 illustrates a block diagram of an exemplary system that facilitates employing software code modules in managed environment according to an aspect of the subject disclosure.

FIG. 5 illustrates a block diagram of exemplary system that provides unloadable managed code modules.

FIG. 6 illustrates an exemplary methodology utilizing software modules in an unloadable fashion within a managed environment.

FIG. 7 illustrates an exemplary methodology that facilitates generating a full description of a static subroutine.

FIG. 8 illustrates an exemplary methodology that facilitates creating an unloadable dynamic subroutine from a full description of a static subroutine.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “analyzer,” “generator,” “store,” “engine,” “aggregator,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

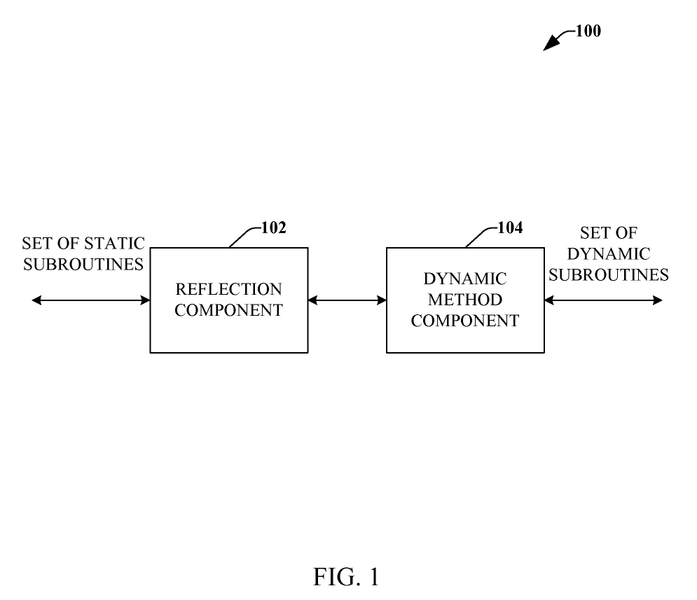

Now turning to the figures, FIG. 1 illustrates a system 100 that facilitates creating managed code that can be dynamically loaded and/or unloaded. Managed code relates to computer program code that is executed under a virtual machine or runtime environment. Unmanaged code, in contrast, is typically executed directly by a processor (e.g., a CPU of a computer or other processing device). The system 100 can include a reflection component 102 that extracts information from a set of static managed subroutines to generate a full description of the static subroutines. The set of subroutines includes, but is not limited to, methods (e.g., associated with a class or object), procedures, functions, subprograms, etc. The subroutines are static in the sense that the subroutines developed and fixed at design time and are unchanging at runtime. The reflection component 102 extracts information for each subroutine in the set. The extracted information can include a list of subroutine arguments, a list of local subroutine variables, body of the subroutine (e.g., logic or instructions of the subroutine), and the like. The list of subroutine arguments can provide number and data type of all parameters of the subroutine. Similarly, the list of local variables can provide number and data type of variables created and utilized within a scope of the subroutine. It is to be appreciated that other information can be extracted so long as it facilitates providing a complete description of the static subroutines.

The system 100 can further include a dynamic method component 104 that provides a set of dynamic subroutines corresponding to the set of static subroutines. A dynamic subroutine can be a method, procedure, function, subprogram, etc., that is generated and employed at runtime. The dynamic method component 104 utilizes the full description of the subroutines provided by the reflection component 102 to create the dynamic subroutines. The dynamic method component 104 can generate dynamic subroutines from descriptions of static subroutines such that the dynamic subroutines can be created, utilized and destroyed as necessary. Accordingly, the resources associated with the dynamic subroutines can be efficiently allocated and reclaimed.

Conventionally, a static subroutine is developed and compiled into an application at design time. Thus, memory resources (e.g., memory footprint) utilized by the static subroutine are allocated so long as the application is executing. These resources are allocated even though the static subroutine can be infrequently invoked. A library (e.g., a collection or set of subroutines) can be employed to provide services or additional function to applications. A static library is a collection that is compiled and/or linked to an application at build-time to produce a static build of an application. Thus, a static library becomes indistinguishable from the application build and consumes memory at all times that the application is executing. A dynamic library is a collection of subroutines that is loaded or linked into an application at runtime (e.g., upon first use or need of a subroutine within the collection). Accordingly, memory resources are not allocated for the subroutines in the dynamic library until the subroutines are needed and subsequently loaded. In some situations, a collection of subroutines (e.g., a library) can be dynamically loaded. In addition to loading or linking at runtime according to need, the library can be unloaded or unlinked at runtime. Dynamic loading enables an application to consume memory resources for code storage only as necessary.

However, not all operating systems, programming languages and/or libraries support dynamic loading. Pursuant to an illustration, in a common language runtime environment (e.g., .NET framework), libraries are often provided as assemblies. An assembly is a set of classes (e.g., objects that include properties and methods) compiled into a common intermediate language. The common intermediate language is a transitional language format within the common language runtime environment. Source code written in a variety of different programming languages can be compiled in the common intermediate language prior to compilation into a machine-specific (e.g., CPU specific) language. Accordingly, developers can employ a plurality of languages in developing a single application or equivalently access the runtime environment functionality from disparate programming languages.

An assembly, once loaded, cannot be unloaded without shutting down an associated application domain. An application domain is an isolation mechanism by which applications executing within the common language runtime environment can be segregated to prevent interference therebetween. This limitation leads to resource bloat (e.g., increased memory usage). Resource bloat is particularly noticeable in applications that support a plug-in model (e.g., application features are enhanced through loading plug-ins implemented as assemblies). As an application can include a plurality of application domains, one possible solution to the unloadability of assemblies is to place each individual assembly employed by an application in a separate application domain. When a loaded assembly is no longer required, the containing application domain can be shut down, effectively unloading the assembly. This technique requires complex application architecture due to application domain management concerns. In addition, employing application domains in this manner has negative performance implications.

The system 100 can be utilized to overcome unloadability of assemblies while also avoiding complex application domain management issues. For example, a set of static methods can be compiled into an assembly. The reflection component 102 can employ reflection techniques on the assembly to extract information regarding the methods therein. The extracted information, for each method in the assembly, can include number of method parameters and their types, number of local variables and their types, a list of intermediate language commands (e.g., method body), and the like. The reflection component 102 generates a full description of each method in the assembly based at least in part on the extracted information. The dynamic method component 104 utilizes the full description of each method to create dynamic methods equivalent to the static methods included in the assembly. The dynamic methods can be instantiated software objects invoked similar to static methods. However, the dynamic methods, as software objects, can be destroyed and the resources reclaimed when no longer needed.

It is to be appreciated that the system 100 can include any suitable and/or necessary interface component (not shown), which provides various adapters, connectors, channels, communication paths, etc. to integrate the reflection component 102 and dynamic method component 104 into virtually any application, operating and/or database system(s) and/or with one another. In addition, the interface component can provide various adapters, connectors, channels, communication paths, etc., that provide for interaction with and between the reflection component 102, the dynamic method component 104, and any other device and/or component associated with the system 100.

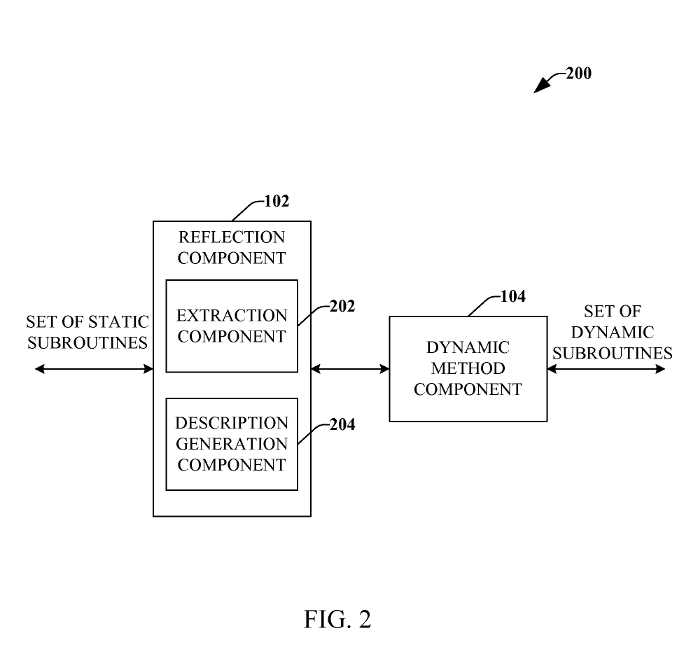

FIG. 2 illustrates a system 200 that facilitates generating unloadable managed code. The system 200 includes a reflection component 102 that employs reflection techniques on a set of static subroutines to provide full descriptions of each subroutine in the set. The system 200 further includes a dynamic method component 104 that utilizes the full descriptions of each subroutine to generate a set of dynamic subroutines equivalent to the static subroutines. The dynamic subroutines can be generated from full descriptions, utilized (e.g., invoked) by an application and discarded as necessary such that allocated resources (e.g., memory consumed by the dynamic subroutines) can be reclaimed to prevent waste and/or application bloat.

The reflection component 102 can include an extraction component 202 that analyzes each subroutine in the set of static subroutines and obtains information regarding the structure of the subroutines. For instance, the information can include subroutine arguments and argument data types, local subroutine variables and variable data types, body instructions of the subroutine, etc. The reflection component 102 can further include a description generation component 204 that provides a full description of each subroutine in the set of static subroutines based upon the obtained information. Pursuant to an illustrative embodiment, the full description can be a data structure that retains the obtained information. The data structure can be utilized by the dynamic method component 104 to generate dynamic subroutines. In an aspect, the dynamic subroutines can be a software class that is instantiated as an object in accordance with the data retained in the full description data structure. The dynamic subroutine object can be invoked as a subroutine and discarded when complete.

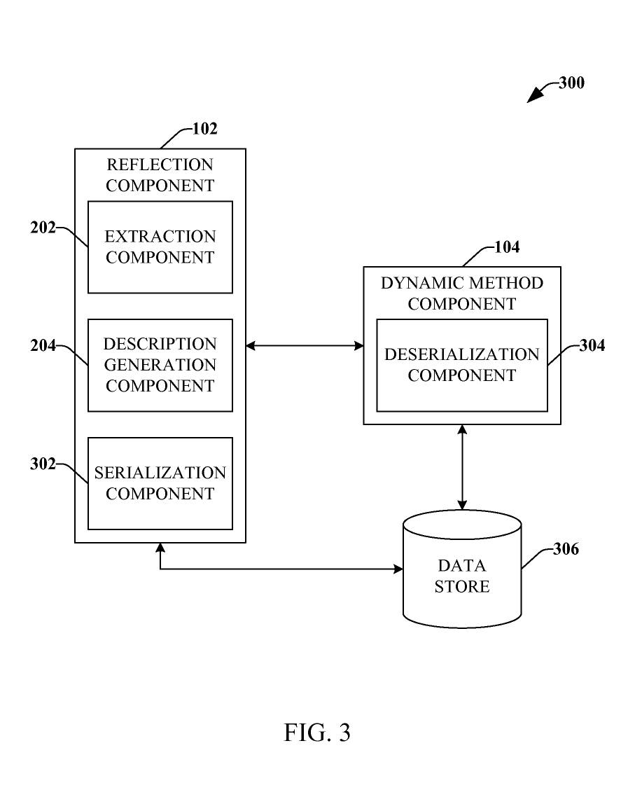

FIG. 3 illustrates a system 300 that facilitates creation of unloadable managed subroutines in accordance with an aspect of the subject disclosure. The system 300 can include a reflection component 102 that extracts information from a set of static managed subroutines to generate a full description of the static subroutines. The reflection component 102 can include an extraction component that extracts information for each subroutine in the set. The extracted information can include a list of subroutine arguments, a list of local subroutine variables, body of the subroutine (e.g., logic or instructions of the subroutine), and the like. The list of subroutine arguments can provide number and data type of all parameters of the subroutine. Similarly, the list of local variables can provide number and data type of variables created and utilized within a scope of the subroutine. It is to be appreciated that other information can be extracted so long as it facilitates providing a complete description of the static subroutines.

The reflection component 102 can further include a description generation component 204 that provides a full description of each subroutine in the set of static subroutines based upon the obtained information. The full description can be embodied as a data structure that retains the information extracted by the extraction component 202. The reflection component 102 can further include a serialization component 302 that serializes the full description (e.g., serializes the data structure representing the full description). Serialization is a process by which an object or data structure is transformed into a series of bytes (e.g., byte stream) such that the object or data structure can be transmitted or retained on a storage medium in a binary format.

The system 300 further includes a dynamic method component 104 that provides a set of dynamic subroutines corresponding to the set of static subroutines. The dynamic method component 104 utilizes the full description of the subroutines provided by the reflection component 102 to create the dynamic subroutines. The dynamic method component 104 includes a deserialization component 304 that deserializes (e.g., unpacks) the full descriptions provided by the reflection component 102.

Pursuant to an illustration, the system 300 can further include a data store 306 that can retain serialized subroutine descriptions. In addition, the data store 306 can index serialized descriptions to facilitate retrieval. For example, the reflection component can generate descriptions of a set of static subroutines (e.g., methods in an assembly). The generated descriptions can be serialized and provided to the data store 306 for indexing and storage. The dynamic method component 304 can retrieve a retained description in response to a request for a subroutine from the static set and create a corresponding dynamic subroutine for consumption by an application.

It is to be appreciated that the data store 306 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM. The data store 306 of the subject systems and methods is intended to comprise, without being limited to, these and any other suitable types of memory. In addition, it is to be appreciated that the data store 306 can be a server, a database, a hard drive, a pen drive, an external hard drive, a portable hard drive, and the like.

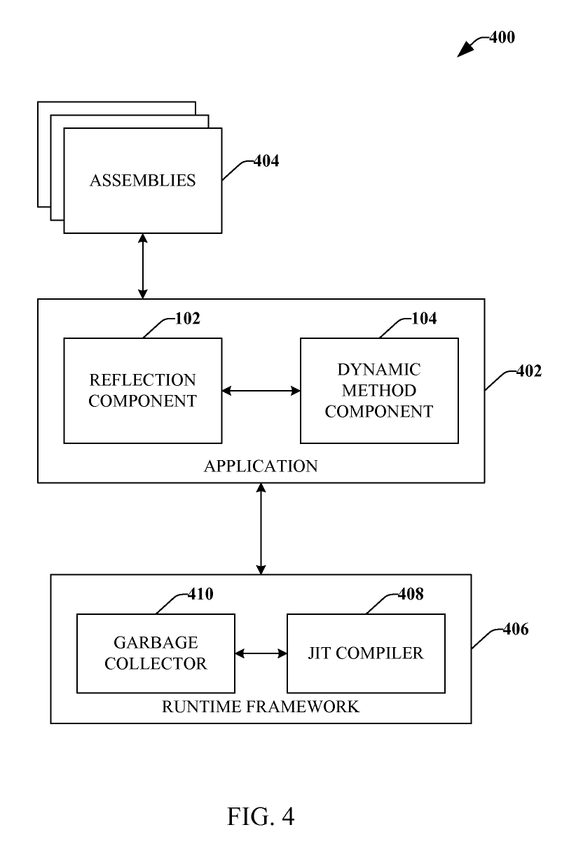

FIG. 4 illustrates a system 400 that facilitates providing unloadable managed code in a common language runtime environment. The system 400 can include an application 402 developed in at least one of a plurality of languages provided in the common language runtime environment. For example, the application 402 can be developed in C#, C++, Visual Basic or other language included in the .NET framework. In accordance with an aspect, the application 402 can include a modular code design, such as but not limited to, a plug-in model. A group of assemblies 404 can be provided that include portions of application code. The assemblies can be loaded into the application when needed. However, once loaded, an assembly cannot be unloaded without shutting down the application 402 or an application domain associated with the assembly.

The application 402 can include a reflection component 102 that extracts information regarding methods in the assemblies 404. The reflection component 102 generates full descriptions of the methods and provides the descriptions to a dynamic method component 104. The dynamic method component 104 generates dynamic methods equivalent to static methods in the assemblies. For example, the dynamic methods can be implemented according to a dynamic method class type and instantiated as a specific object corresponding to a static method in an assembly. The dynamic method can be invoked or utilized by the application 402 in a manner substantially similar to employing the corresponding static method in the assembly. However, the application 402 can discard the dynamic method when no longer required so that resources (e.g., memory) can be reclaimed by the system.

According to another aspect, the reflection component 102 can serialize descriptions of methods in the assemblies and store the serialized descriptions in a data store (not shown). The dynamic method component 104 can retrieve a description of a method from the data store only when needed by the application 402. The description can include information such as, but not limited to, number and data types of method parameters, number and data types of local method variables, intermediate language commands comprising the body of the method, etc. The dynamic method component 104 creates a dynamic method object based, at least in part, on the description information.

The system 400 can further include a runtime framework 406 that provides a common language runtime environment for the application 402. The runtime framework 406 provides an illusion of a virtual machine to shield software developers from requiring knowledge of specific capabilities of a CPU executing applications. In addition, the runtime framework 406 can provide memory management services to the application 402. To these ends, the runtime environment can include a just-in-time (JIT) compiler 408 and a garbage collector 410. The JIT compiler 408 provides runtime compilation or conversion of code to a machine-specific format prior to execution on a CPU. Typically, assemblies include methods compiled into a common intermediate language. Upon creation of equivalent dynamic methods at runtime by the reflection component 102 and the dynamic method component 104, the JIT compiler 408 transforms the intermediate language code of the dynamic method into machine-specific (e.g., CPU specific) code to enable execution. The garbage collector 410 provides automatic memory management to application 402. For example, the garbage collector 410 reclaims memory allocated to objects of an application that cannot be accessed or changed by the application. Once a generated dynamic method is no longer needed by the application 402, the application 402 can discard the dynamic method. The discarded method can be identified by the garbage collector 410. The garbage collector 410 can destroy the method and resources allocated to the method can be reclaimed.

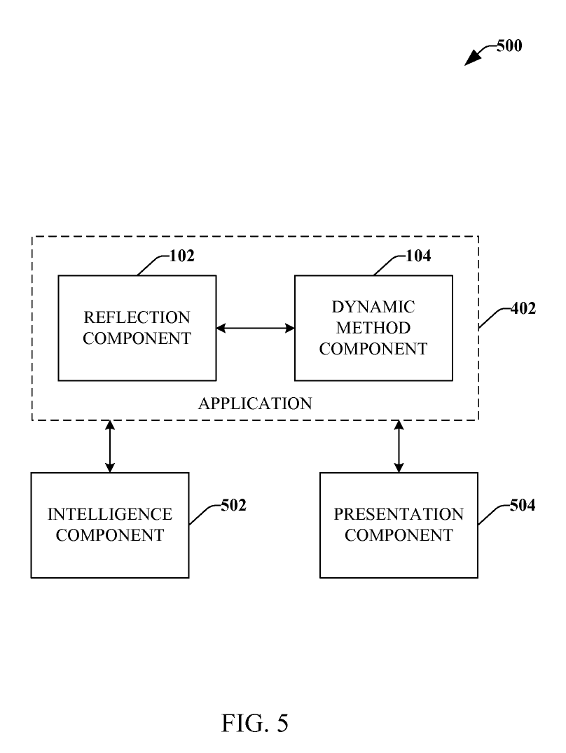

FIG. 5 illustrates a system 500 that employs intelligence to facilitate utilizing dynamic subroutines generated from static subroutines. The system 500 can include the application 402 that includes the reflection component 102 and dynamic method component 104 which can be substantially similar to respective applications, reflection components and dynamic method components described in previous figures. The system 500 further includes an intelligence component 502. The intelligence component 502 can be utilized by the application 402 to facilitate converting static subroutines into dynamic subroutines created at runtime. For example, the intelligence component 502 can infer static subroutines of an application or application source code that can be transformed into dynamic methods to improved performance in terms of resource utilization. In addition, the intelligence component 502 can infer when a dynamic subroutine is required during execution and automatically instruct the reflection component 102 and dynamic method component 104 to acquire a corresponding static subroutine and generate a full description. Moreover, the intelligence component 502 can infer a subset of subroutines in a set or library that includes likely candidates for translation to a dynamic subroutine. For example, subroutines utilized infrequently by an application can be converted to dynamic subroutines while heavily employed subroutines can be statically linked. Accordingly, the intelligence component 502 can analyze performance characteristics of an application to determine situations when memory utilization is outweighed by a need for efficient execution or vice versa.

The intelligence component 502 can employ value of information (VOI) computation in order to identify static subroutines that are ideal candidates for conversion to dynamic subroutines. For instance, by utilizing VOI computation, the most ideal and/or appropriate subroutines for a particular application can be determined. Moreover, it is to be understood that the intelligence component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, . . . xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The application 402 can further utilize a presentation component 504 that provides various types of user interfaces to facilitate interaction between a user and any component coupled to the application 402. As depicted, the presentation component 504 is a separate entity that can be utilized with the application 402. However, it is to be appreciated that the presentation component 504 and/or similar view components can be incorporated into the application 402 and/or a stand-alone unit. The presentation component 504 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into application 402.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

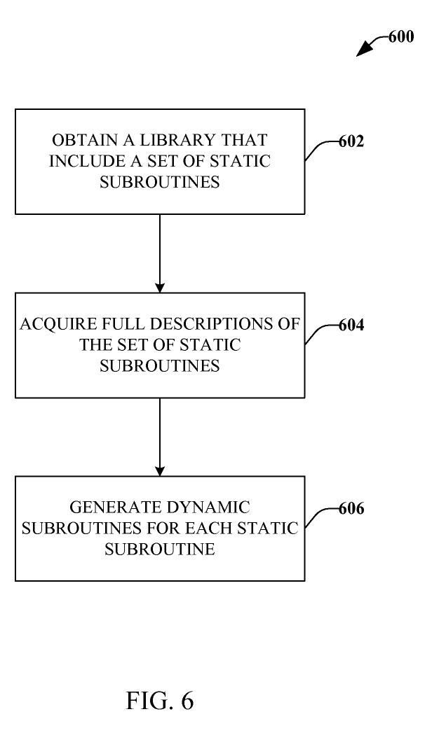

FIGS. 6-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 6 illustrates a method 600 that facilitates utilizing software modules in an unloadable fashion within a managed environment. At reference numeral 602, a library that includes a set of static subroutines is obtained. The library can be a dynamic library that is loaded or linked into an application at runtime when a subroutine contained therein is first required. Pursuant to an illustration, the library can be an assembly deployed in a common language runtime environment (e.g., a managed environment). Conventionally, upon loading the library (or assembly), the library cannot be unloaded.

At reference numeral 604, full descriptions of each subroutine in the set of subroutines are acquired. Pursuant to an illustration, reflection techniques can be employed on a static subroutine to obtain information about structure of the subroutine. For example, the information can include a list of subroutine arguments, a list of local subroutine variables, body of the subroutine (e.g., logic or instructions of the subroutine), and the like. The list of subroutine arguments can provide number and data type of all parameters of the subroutine. Similarly, the list of local variables can provide number and data type of variables created and utilized within a scope of the subroutine. It is to be appreciated that other information can be extracted so long as it facilitates providing a complete description of the static subroutines. Full descriptions can be generated based upon the information obtained via reflection. For instance, a data structure can be provided that represents a description of a subroutine wherein the data structure organizes and retains the obtained structure information.

At reference numeral 606, dynamic subroutines are generated corresponding to the static subroutines. A dynamic subroutine can be a method, procedure, function, subprogram, etc., that is generated and employed at runtime. The dynamic subroutines can be created, utilized and destroyed as necessary. Accordingly, the resources associated with the dynamic subroutines can be efficiently allocated and reclaimed.

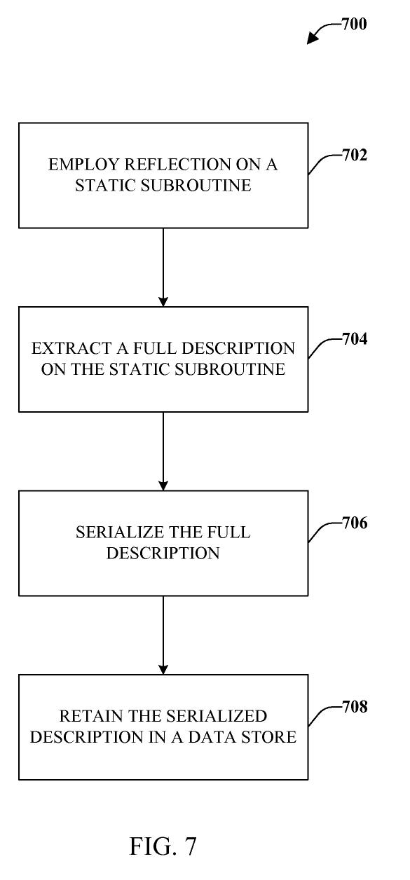

FIG. 7 illustrates a method 700 that facilitates generating a full description of a static subroutine. At reference numeral 702, reflection techniques are employed on a static subroutine. Reflection enables a computer program to acquire information regarding its own structure and data. At reference numeral 704, a full description of the static subroutine (including subroutine instructions) is extracted. At reference numeral 706, the full description is serialized. Serialization is a process by which an object or data structure is transformed in a stream of bytes that can be transmitted or stored in binary form. At reference numeral 708, the serialized description is retained in a data store for later retrieval.

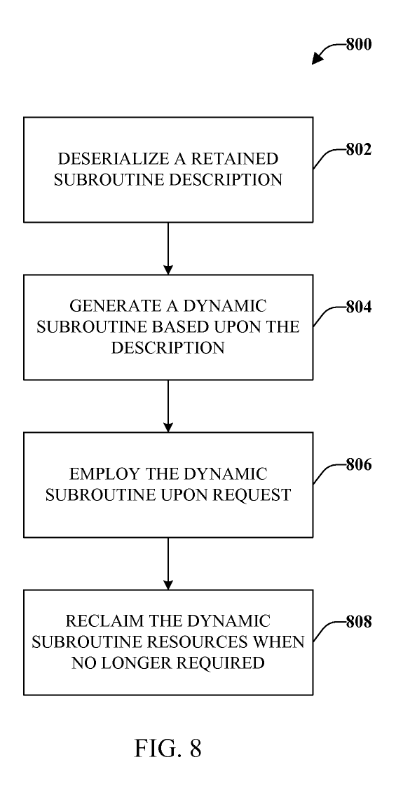

FIG. 8 illustrates a method 800 that facilitates creating an unloadable dynamic subroutine from a full description of a static subroutine. At reference numeral 802, a full description of a subroutine is deserialized. The full description can be stored in a data store in a serialized format. At reference numeral 804, a dynamic subroutine is generated based upon the deserialized or unpacked description. At reference numeral 806, the dynamic subroutine is invoked upon request in place of the corresponding static subroutine. At reference numeral 808, resources allocated to the dynamic subroutine are reclaimed when the dynamic subroutine is no longer required. The resources can be reclaimed by, for example, a garbage collector provided by a common language runtime environment.

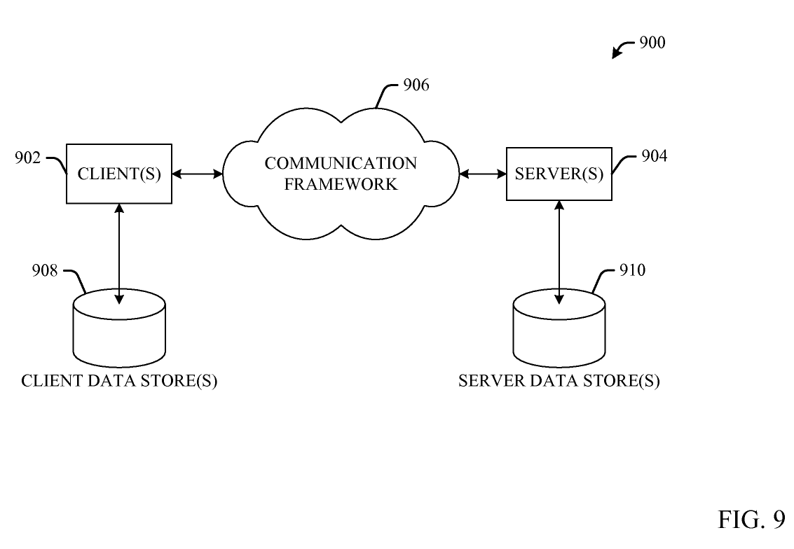

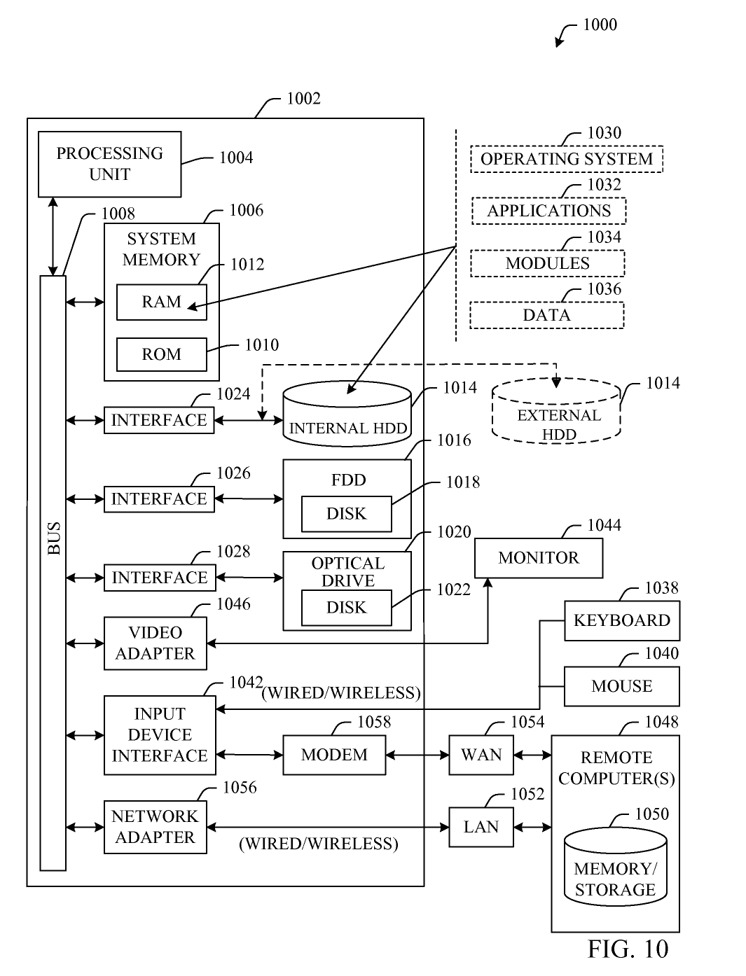

In order to provide additional context for implementing various aspects of the claimed subject matter, FIGS. 9-10 and the following discussion is intended to provide a brief, general description of a suitable computing environment in which the various aspects of the subject innovation may be implemented. For example, a reflection component that generates full descriptions of static subroutines and a dynamic method component that creates dynamic subroutines at runtime based upon the descriptions, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that provides unloadable managed software code, comprising:
a reflection component that extracts information from a set of static subroutines to produce full descriptions for each subroutine in the set of static subroutines; and
a dynamic method component that generates dynamic subroutines at runtime of an application based upon the full descriptions of the static subroutines, the dynamic subroutines provide substantially equivalent functionality to the static subroutines.

2. The system of claim 1, the reflection component comprises an extraction component that analyzes each subroutine in the set of static subroutines to obtain the information.

3. The system of claim 2, the extraction component employs reflection techniques to inspect structure and data of the static subroutines.

4. The system of claim 1, the reflection component comprises a description generation component that produces a full description of a static subroutine based at least in part on the extracted information.

5. The system of claim 1, the extracted information includes at least a list of subroutine parameters, a list of local subroutine variables and a list of subroutine instructions.

6. The system of claim 5, the list of subroutine parameters includes a number of parameters and a respective data type of each parameter.

7. The system of claim 5, the list of local subroutine variables includes a number of variables and a respective data type of each variable.

8. The system of claim 1, the full descriptions are data structures that retain the extracted information.

9. The system of claim 1, further comprising a serialization component that serializes the full descriptions.

10. The system of claim 9, further comprising a data store that indexes and retains the serialized descriptions.

11. The system of claim 9, further comprising a deserialization component that unpacks the serialized descriptions prior to generation of the dynamic subroutines.

12. The system of claim 1, the set of static subroutines include static methods retains in an assembly.

13. The system of claim 1, further comprising a just-in-time compiler that converts the generated dynamic subroutines into a machine-specific format to enable execution.

14. The system of claim 1, further comprising a garbage collector that reclaims resources allocated to a dynamic subroutine

15. A computer-implemented method that facilitates unloading managed code modules, comprising:
obtaining an assembly that includes a set of static subroutines compiled in a common intermediate language;
employing reflection on the set of static subroutines to generate full descriptions of each subroutine in the set of subroutines;
instantiating dynamic subroutine objects based at least in part on the full descriptions; and
compiling the dynamic subroutine objects at runtime to create dynamic subroutines formatted in a machine-specific language.

16. The method of claim 15, further comprising:
serializing the full descriptions as a stream of bytes; and
indexing and retaining the full descriptions in a data store.

17. The method of claim 16, further comprising:
retrieving a full description from the data store; and
deserializing the retrieved description prior to instantiating a dynamic subroutine object.

18. The method of claim 15, further comprising invoking the dynamic subroutines.

19. The method of claim 15, further comprising reclaiming resources allocated to the dynamic subroutines.

20. A system that generates unloadable managed code modules, comprising:
means for providing a set of static subroutines as a separate code module employable by an application;
means for extracting information regarding structure of the set of static subroutines;
means for generating a full description of each static subroutine based upon extracted information;
means for creating a dynamic subroutine at runtime based at least in part on the full description;
means for compiling the dynamic subroutine into a machine-specific format; and
means for reclaiming resources allocated to the dynamic subroutine when the subroutine is discarded.
